(19) United States
(12) Patent Application Publication
(10) Pub. No.: US 2025/0004136 A1
(43) Pub. Date: Jan. 2, 2025

(54) USING A DRONE TO AUTOMATICALLY OBTAIN INFORMATION ABOUT A STRUCTURE

(71) Applicant: Telefonaktiebolaget LM Ericsson (publ), Stockholm (SE)

(72) Inventors: Volodya GRANCHAROV, Solna (SE); Steven COMBES, Worthing (GB); Sigurdur SVERRISSON, Kungsängen (SE)

(73) Assignee: Telefonaktiebolaget LM Ericsson (publ), Stockholm (SE)

(21) Appl. No.: 18/576,615

(22) PCT Filed: Jul. 5, 2021
(86) PCT No.: PCT/EP2021/068439

§ 371 Date: Jan. 4, 2024

(51) Int. Cl. G01S 17/89; G01S 7/48; G01S 17/08; G05D 1/689; G05D 105/80; G05D 109/20; G05D 111/10

(52) U.S. Cl. CPC G01S 17/89; G01S 7/4808; G01S 17/08; G05D 1/689; G05D 2105/89; G05D 2109/20; G05D 2111/17

(57) ABSTRACT

A method (600) for obtaining information about a structure (101) using a drone (102) equipped with a sensor system (103). The method includes, during a first period of time and while the drone's sensor system is pointing towards the structure, using (s602) the sensor system to obtain first depth data. The method also includes obtaining (s604) a first height value, Z1, indicating or being based on the height of the drone above a bottom point of the structure during the first period of time. The method also includes using (s606) the first depth data to determine a first vertical coordinate representing a top point of the structure. The method further includes estimating (s608) a height of the structure, wherein estimating the height of the structure comprises using the first vertical coordinate and the first height value, Z1, to estimate the height of the structure.

### TECHNICAL FIELD

Disclosed are embodiments related to obtaining information about a structure using a drone equipped with a sensor system.

### BACKGROUND

A mobile network operator may have many cell sites (e.g., locations at which a cell tower is located and antennas or other equipment may be connected to the tower). In order to manage the equipment at these many different cell sites, the mobile network operator may create a “digital twin” of the sites (i.e., a digital replica of the site), an example of which is a three-dimensional (3D) point cloud of the site. Consistent data acquisition is an important step in the process of creating digital twins of the cell sites. In case of 3D point clouds generated by means of imagery data obtained using a camera carried by an aerial vehicle (hereafter “drone”), data consistency means correct drone position relative to the object of interest (e.g., the cell tower or other structure). For a Tower Site Overview (TSO) orbit, the drone's camera is usually pointed down at the cell tower at 45° and the drone distance from the tower is such that the projection of the tower in the image plane occupies a central area of the image.

In order to position the drone in the preferred TSO orbit around the cell tower to be analyzed, it is helpful to obtain information about the cell tower, such as, for example the three-dimensional (3D) point that coincides with a centroid of the cell tower (e.g., a centroid of a top surface of the tower) as well as the 3D points that coincide with the top and bottom of the structure, respectively.

### SUMMARY

Certain challenges presently exist. For instance, the optimal drone positioning is presently achieved by a person (the “pilot”) manually navigating the drone to determine the 3D points mentioned above. Such a manual process leads to inconsistencies in the collected data and consequently lower quality of the generated 3D point clouds.

Accordingly, in one aspect there is provided a method for obtaining information about a structure using a drone equipped with a sensor system. The method includes, during a first period of time and while the drone's sensor system is pointing towards the structure, using the sensor system to obtain first depth data. The method also includes obtaining a first height value, Z1, indicating or being based on the height of the drone above a bottom point of the structure during the first period of time. The method also includes using the first depth data to determine a first vertical coordinate representing a top point of the structure. The method further includes estimating a height of the structure, wherein estimating the height of the structure comprises using the first vertical coordinate and the first height value, Z1, to estimate the height of the structure.

In another aspect there is provided an apparatus for obtaining information about a structure using a drone equipped with a sensor system. The apparatus is configured to, during a first period of time and while the drone's sensor system is pointing towards the structure, use the sensor system to obtain first depth data. The apparatus is further configured to obtain a first height value, Z1, indicating or being based on the height of the drone above a bottom point of the structure during the first period of time. The apparatus is further configured to use the first depth data to determine a first vertical coordinate representing a top point of the structure. The apparatus is further configured to estimate a height of the structure, wherein estimating the height of the structure comprises using the first vertical coordinate and the first height value, Z1, to estimate the height of the structure.

In another aspect there is provided a method for obtaining coordinates associated with a structure. The method includes positioning a drone above the structure, wherein the drone is equipped with a sensor system. The method also includes, while the drone is above the structure and the drone's sensor system is pointing towards the structure, using the sensor system to obtain first depth data. The method also includes based on the first depth data, identifying a point-of-interest on the structure. The method also includes determining a position of the point-of-interest in a two dimensional plane. The method also includes based on the determined position of the point-of-interest in the two dimensional plane, determining whether or not the drone should be re-positioned. The method also includes, if it is determined that the drone should be re-positioned, causing the drone to move to a new position. The method also includes determining x and y coordinates of a current position of the drone. The method also includes setting x and y coordinates for the point-of-interest based on the determined x and y coordinates of the current position of the drone.

In another aspect there is provided an apparatus for obtaining coordinates associated with a structure. The apparatus is configured to position a drone above the structure, wherein the drone is equipped with a sensor system. The apparatus is further configured to, while the drone is above the structure and the drone's sensor system is pointing towards the structure, use the sensor system to obtain first depth data. The apparatus is further configured to, based on the first depth data, identifying a point-of-interest on the structure. The apparatus is further configured to determine a position of the point-of-interest in a two dimensional plane. The apparatus is further configured to, based on the determined position of the point-of-interest in the two dimensional plane, determine whether or not the drone should be re-positioned. The apparatus is further configured such that, if it is determined that the drone should be re-positioned, the apparatus causes the drone to move to a new position. The apparatus is further configured to determine x and y coordinates of a current position of the drone. The apparatus is further configured to set x and y coordinates for the point-of-interest based on the determined x and y coordinates of the current position of the drone.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium.

An advantage of the embodiments disclosed herein is that they reduce the cost and improve the accuracy of all applications related to digitalization of telecom assets. In addition to the outlined telecom scenario, the embodiments are applicable in other situations as well, such as, for example, estimating points of interest in high-voltage transmission poles and similar tall structures.

### BRIEF DESCRIPTION OF THE DRAWINGS

The accompanying drawings, which are incorporated herein and form part of the specification, illustrate various embodiments.

FIG. 1 illustrates a cell tower and a drone having a sensor system for determining one or more points-of-interest with respect to the cell tower.

FIG. 2 illustrates a manual process for determining points-of-interest with respect to the cell tower.

FIG. 3 illustrates a process for automatically obtaining an estimate of the height of the cell tower according to some embodiments.

FIG. 4 illustrates a process of estimating the coordinates of the center of the cell tower according to some embodiments.

FIG. 5 illustrates a depth filtering operation according to some embodiments.

FIG. 6 is a flowchart illustrating a process according to some embodiments.

FIG. 7 is a flowchart illustrating a process according to some embodiments.

FIG. 8 shows an apparatus according to some embodiments.

### DETAILED DESCRIPTION

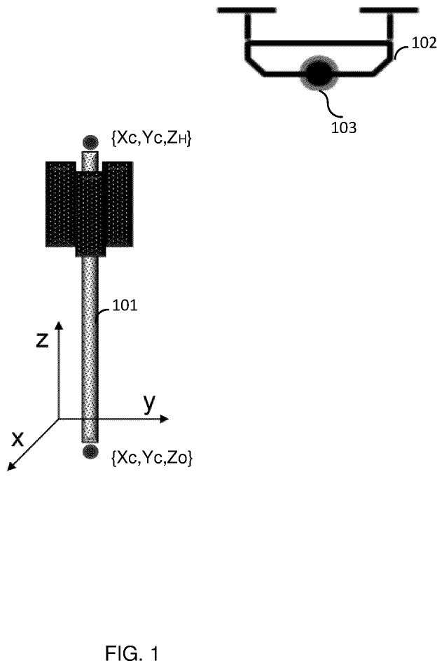

FIG. 1 illustrates a cell tower 101 and a drone 102 having a sensor system 103 for determining one or more points-of-interest with respect to cell tower 101. In this example, the cell tower 101 has two points-of-interest: 1) a first point located at the 3D point {X_{C}, Y_{C}, Z_{H}} (i.e., a top center point of the tower) and 2) a second point located at the 3D point {X_{C}, Y_{C}, Z₀} (i.e., a bottom center point of the tower). Accordingly, the center of the tower on the XY plane is denoted {X_{C}, Y_{C}}. Because Z₀ is the altitude at the drone's home point, which is known, in order to determine these points-of-interest, the drone must implement a process for determining {X_{C}, Y_{C}} and Z_{H}.

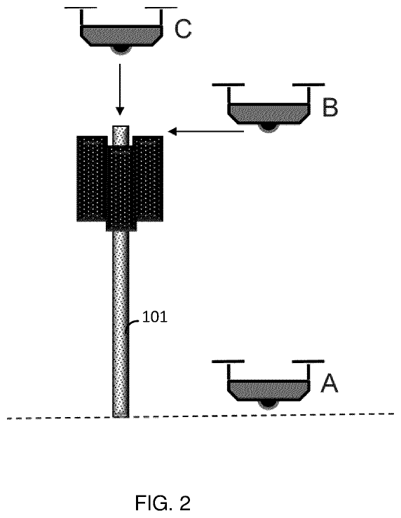

As noted above, {X_{C}, Y_{C}} and Z_{H} are presently estimated by having a pilot manually navigate the drone. Such a manual process leads to inconsistencies in the collected data and consequently lower quality of the generated 3D point clouds. FIG. 2 illustrates this error-prone manual process that drone pilots follow to determine the points of interest required for correct drone positioning in the data acquisition process. In step 1 the pilot flies the drone straight up from the home point A with camera pointing towards the cell tower. In step 2, the pilot observes the height of the tower at drone position B. In step 3, the pilot positions the drone 5m above the tower (drone position C) with camera pointing down and selects the point of interest, center of the tower on XY plane. This manual procedure is a main obstacle that prevents automation of the drone flight and data capture process. This process brings significant cost and inserts uncertainty to the digitalization of telecom assists.

This disclosure describes a fully automated way to estimate points-of-interest, which in turn enables an automated data capture process. The embodiments disclosed here may be applied to any structure as they do not require trained visual object detection, and, therefore, there is no requirement the type of installation to be previously known. Currently deployed industry practices are to manually position the drone for data acquisition and 3D points of interest are estimated only after the 3D model is created. The embodiments disclosed herein provide estimation of the top center of the cell tower at run-time, which improves real-time orbit control of the drone.

A first process is performed for estimating the height of the cell tower using drone 102, which is equipped with sensor system 103 for estimate the depth (i.e., distances) in the scene (e.g., the sensor system comprises a Light Detection and Ranging (LiDAR) scanner that comprises a laser and a light detector). The process includes the drone starting a position A (see FIG. 2) and flying vertically to position B (see FIG. 2).

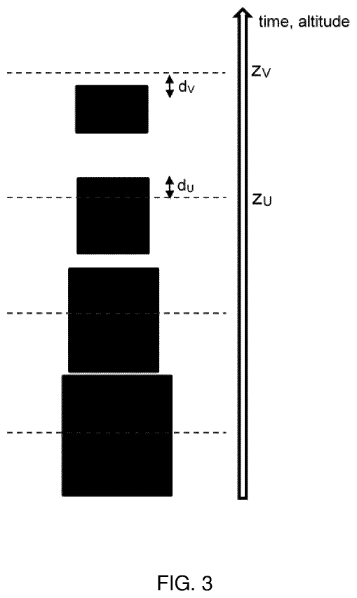

While the drone is moving from A to B, the sensor system 102 (e.g., laser and light detector) is oriented towards the cell tower. In this way, every 2 s, for example, at higher and higher altitude levels depth data is obtained. This depth data (a.k.a., depth map), which comprises a set of distance values, is then filtered (e.g., all distance values (distance from light detector) larger than 20 m are removed) to produce a filtered depth map (i.e., filtered depth data). In one embodiment, each distance value in the filtered depth map is associated with the coordinates of a pixel in an image. Next, a rectangular shape is fitted around the set of depth values as shown in FIG. 3. That is, FIG. 3 illustrates the rectangular shapes fitted on the filtered depth data (a.k.a., filtered depth map). The dotted lines that split the image area in two equal parts by going through the half of image height corresponds to a particular drone altitude.

In one embodiment, the height of the cell tower is calculated as a weighted sum of two selected drone altitudes, which are denoted Zu and Zv. These drone altitudes are selected because, as shown in FIG. 3, one these altitudes (Zu) is a known distance (represented by dᵤ) below the top of the cell tower while the other (Zv) is a known distance (represented by dᵥ) above the top of the cell tower as indicated by the filtered depth maps. That is, as shown in FIG. 3, the vertical distance between Zu and Z_{H} is represented by dᵤ and the vertical distance between Zv and Z_{H} is represented by dᵥ. More specifically, in one embodiment, dᵤ and dᵥ are distances measured in units of pixels. For example, dᵤ is the number of pixels between a vertical coordinate in a first image representing the top of the tower and a reference vertical coordinate in the first image representing Zu. Likewise, dᵥ is the number of pixels between a vertical coordinate in a second image representing the top of the tower and a reference vertical coordinate in the second image representing Zv.

Knowing Zu, Zv, dᵤ, and dᵥ, Z_{H} (height of the cell tower) can be calculated according to the following:

$$IF {d}_{v} < {d}_{u}$$

$${Z}_{H} = ( \frac{{d}_{v}}{{d}_{v} + {d}_{u}} ) {Z}_{u} + ( 1 - \frac{{d}_{v}}{{d}_{v} + {d}_{u}} ) {Z}_{v} ,$$

$$ELSE$$

$${Z}_{H} = ( 1 - \frac{{d}_{u}}{{d}_{v} + {d}_{u}} ) {Z}_{u} + ( \frac{{d}_{u}}{{d}_{v} + {d}_{u}} ) {Z}_{v} .$$

In another embodiment, Z_{H} can be calculated according to any one of the following:

$${Z}_{H} = Zu + {md}_{u} ,$$

$${Z}_{H} = Zv - {md}_{v} , or$$

$${Z}_{H} = ( ( Zu + {md}_{u )} + ( Zv - {md}_{v} ) ) / 2 ,$$

wherein mdv and mdv are in units of length (e.g., meters, inches, etc.) and are derived from dᵤ and dᵥ, respectively.

For example, mdu and mdv may be derived as follows:

$${md}_{u} = \frac{{D}_{avg}}{f} {d}_{u} , and$$

$${md}_{v} = \frac{{D}_{avg}}{f} {d}_{v} ,$$

where f is the focal length of the sensor system used to produce the above mentioned first and second images and Davg is the average depth in, for example, meters (as measured by, for example, the LiDAR scanner). The averaging is over the black rectangular shape, as illustrated in FIG. 3.

Another process is performed for obtaining an estimate of the center of the tower on an XY-plane (i.e., obtaining {Xc, Yc}). In a first step of the process, an initial rough estimate of {Xc, Yc} is obtained as the drone moves from position B towards position C (position above the tower, as indicated in FIG. 2), while the measurement sensors are pointing down.

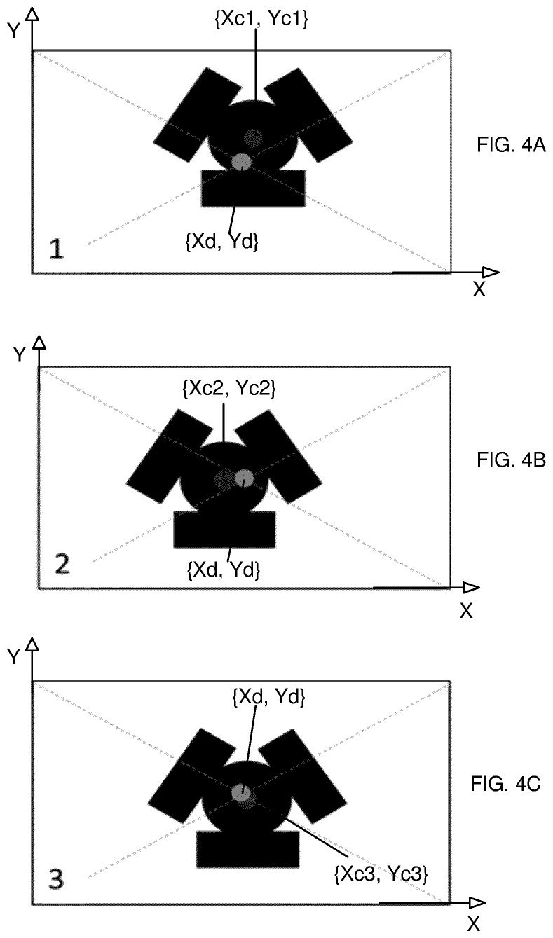

Next, a refinement process is performed as follows:
Step 1: from the current drone position (i.e., while the drone is above the structure and the drone's sensor system is pointing towards the structure) use the sensor system to obtain filtered depth data.
Step 2: based on the filtered depth data, identify the center of the tower and determine the position of the center of the cell tower in a rectangular (2D) image, wherein the center of this image (i.e., {Xd, Yd} as shown in FIGS. 4A, 4B, and 4C) represents the position of the drone. The filtered depth data includes a set of data points, wherein each data point has a location {x,y} within the image. The center of the cell tower can be determined by calculating the centroid of the data points within the image.
Step 3: based on the determined position of the center of the cell tower in the image, determine whether the position of center of the tower is close enough to the center of the image (i.e., is within a threshold distance of the center of image).
Step 4: if the position of the center of the cell tower is not close enough to the center of the image, then move the drone so that the position of the center of the cell tower moves closer to the center of the image and then go back to step 1. In one embodiments, to improve the drone's location, the drone is oriented according to the direction Q, where Q is equal to: arctan ((Yc−Yd)/(Xc−Xd)), and the done is moved a distance equal to: ((Xc−Xd)²+(Yd−Yd)²)^{1/2} in direction Q.
Step 5: determine x and y coordinates of a current position of the drone (this step is reached only if the center of the cell tower is within the threshold distance from the center of the image).
Step 6: set x and y coordinates for the center of the tower based on the determined x and y coordinates of the current position of the drone.

This above described process is illustrated in FIGS. 4A, 4B, and 4C. FIG. 4A illustrates a first iteration of the process, wherein {Xd, Yd} is the center of the image, which is the position of the drone projected on the 2D plane and {Xc1, Yc1} represents the position of the center of the cell tower in the image. In the second iteration of the process (see FIG. 4B), the position of the center of the cell tower in the next image {Xc2, Yc2} is now closer to {Xd, Yd}, but still not close enough. In the third iteration of the process (see FIG. 4C), the position of the center of the cell tower in the next image {Xc3, Yc3} is now close enough to {Xd, Yd} (i.e., D<T, where D=((Xd−Xc)²+(Yd−Yc)²)^{1/2}, and T is the threshold value.

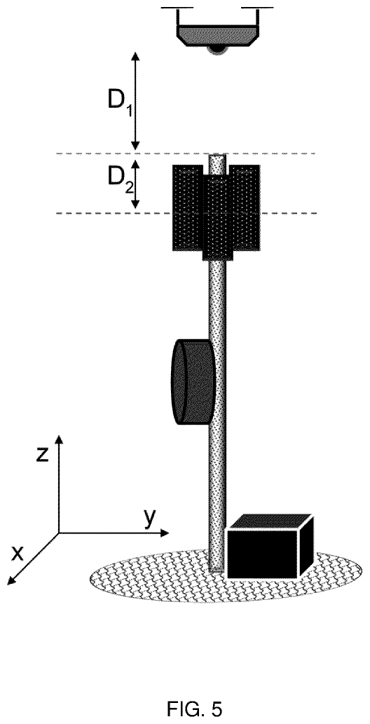

The depth data obtained in step 1 is filtered depth data, which is obtained as shown in FIG. 5. FIG. 5 illustrates a depth filtering operation at a given drone position. The filtering removes all points with depth larger than D₁+D₂. Here D₁ is the 5 meter distance from the drone to the top of the tower, but in case of uncertainty in the drone altitude, D₁ could be also estimated as the depth of closest objects in the depth map. D₂ is a safety margin, set to, for example, 1 meter, added to compensate for cases D₁ estimate is smaller than the actual value due to outlier depth points. D₁+D₂ determines the threshold beyond which all points in the image plain are rejected (all points with depth larger than D₁+D₂ are removed and do not contribute to the cluster of depth points used to determine center of the tower).

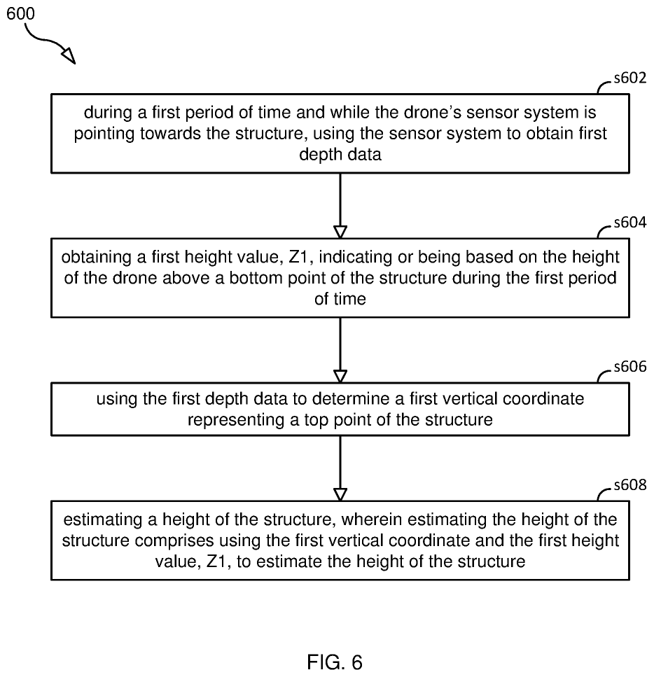

FIG. 6 is a flowchart illustrating a process 600 according to an embodiment for obtaining information about a structure (e.g., cell tower 101) using a drone equipped with a sensor system (e.g. drone 102). Process 600 may begin in step s602. Step s602 comprises, during a first period of time and while the drone's sensor system is pointing towards the structure, using the sensor system to obtain first depth data. Step s604 comprises obtaining a first height value, Z1, indicating or being based on the height of the drone above a bottom point of the structure (e.g., a height above the ground) during the first period of time. Step s606 comprise using the first depth data to determine a first vertical coordinate representing a top point of the structure. Step s608 comprises estimating a height of the structure, wherein estimating the height of the structure comprises using the first vertical coordinate and the first height value, Z1, to estimate the height of the structure.

In some embodiments estimating the height of the structure comprises using the determined first vertical coordinate and a first reference vertical coordinate to determine a first distance value, d1 (e.g., dᵤ or dᵥ, described above); and using d1 and Z1 to estimate the height of the structure. In some embodiments the process also includes, during a second period of time and while the drone's sensor system is pointing towards the structure, using the sensor system to obtain second depth data; obtaining a second height value, Z2, indicating or being based on the height of the drone above a bottom point of the structure during the second period of time; and using the second depth data to determine a second vertical coordinate representing a top point of the structure, wherein estimating the height of the structure further comprises using the second vertical coordinate and the second height value, Z2, to estimate the height of the structure. In some embodiments estimating the height of the structure further comprises: using the determined second vertical coordinate and a second reference vertical coordinate to determine a second distance value, d2; and using d1, d2, Z1, and Z2 to estimate the height of the structure.

In some embodiments the first depth data consists of a first set of distance values, the first depth data is filtered depth data that was filtered such that each distance value included in the first set of distance values is not greater than a threshold distance, the second depth data consists of a second set of distance values, and the second depth data is filtered depth data that was filtered such that each distance value included in the second set of distance values is not greater than the threshold distance.

In some embodiments estimating the height of the structure using d1, d2, Z1, and Z2 comprises: calculating (d2/(d1+d2))×Z1+(1−(d2/(d1+d2)))×Z2, or calculating (1−(d1/(d1+d2)))×Z1+(d1/(d1+d2)))×Z2. In some embodiments d1 indicates a number of pixels between the first vertical coordinate and the first reference vertical coordinate, and d2 indicates a number of pixels between the second vertical coordinate and the second reference vertical coordinate.

In some embodiments estimating the height of the structure using d1, d2, Z1, and Z2 comprises calculating ((Z1+d1)+(Z2−d2))/2.

In some embodiments estimating the height of the structure comprises calculating: Z1+d1 or Z1−d1.

In some embodiments the sensor system comprises a laser and a light detector (e.g., the sensor system comprises a LiDAR scanner).

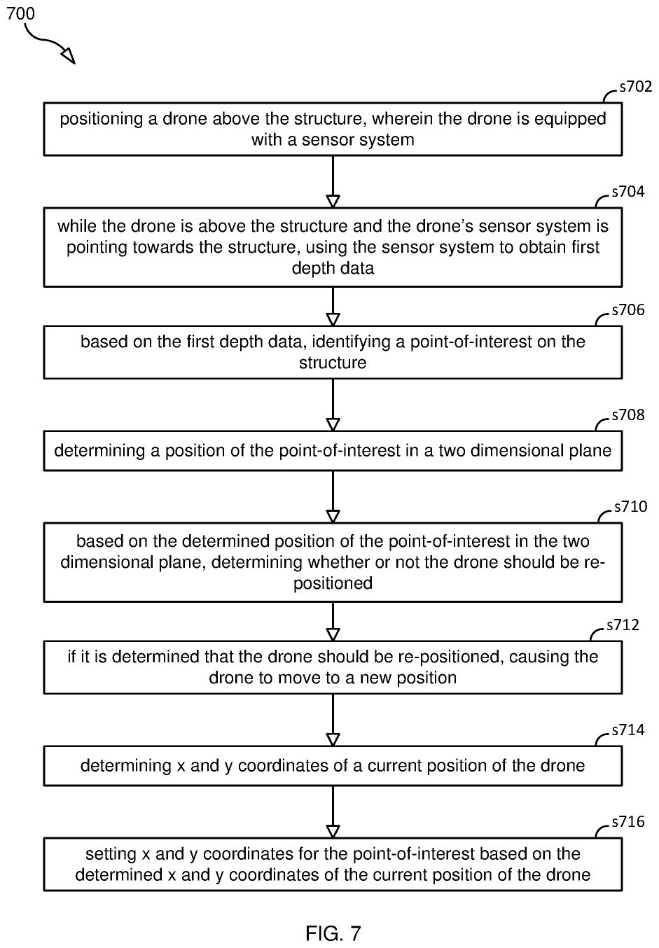

FIG. 7 is a flowchart illustrating a process 700 according to an embodiment for obtaining coordinates associated with a structure (e.g., cell tower 101). Process 700 may begin in step s702. Step s702 comprises positioning a drone (e.g., drone 102) above the structure, wherein the drone is equipped with a sensor system. Step s704 comprises, while the drone is above the structure and the drone's sensor system is pointing towards the structure, using the sensor system to obtain first depth data. Step s706 comprises, based on the first depth data, identifying a point-of-interest on the structure. Step s708 comprises determining a position of the point-of-interest in a two dimensional plane. Step s710 comprises, based on the determined position of the point-of-interest in the two dimensional plane, determining whether or not the drone should be re-positioned. Step s712 comprises, if it is determined that the drone should be re-positioned, causing the drone to move (e.g., fly) to a new position. Step s714 comprises determining x and y coordinates of a current position of the drone. And step s716 comprise setting x and y coordinates for the point-of-interest based on the determined x and y coordinates of the current position of the drone.

In some embodiments, the process also includes, prior to positioning the drone above the structure, estimating a height of the structure. In some embodiments, estimating the height of the structure comprises performing process 600.

In some embodiments, the sensor system comprises a laser and a light detector.

In some embodiments, the point-of-interest is a centroid.

In some embodiments the first depth data consists of a first set of distance values, and the first depth data is filtered depth data that was filtered such that each distance value included in the first set of distance values is not greater than a threshold distance. In some embodiments, the threshold distance (TD) is based on the distance between the drone and the top of the tower (i.e., D1 shown in FIG. 5). For example, in one embodiments TD=D1+D2.

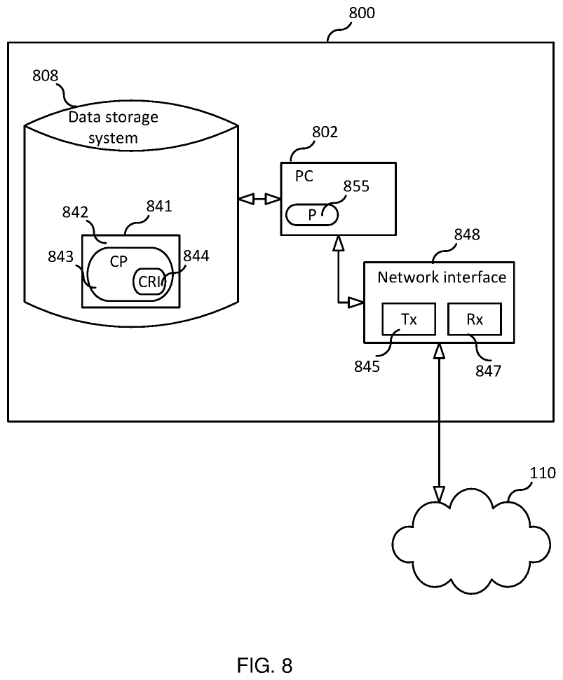

FIG. 8 is a block diagram of an apparatus 800, according to some embodiments, for performing process 700. Apparatus 800 (or any portion thereof) may be carried by drone or may be remote from the drone. As shown in FIG. 8, apparatus 800 may comprise: processing circuitry (PC) 801, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 800 may be a distributed computing apparatus); at least one network interface 848 comprising a transmitter (Tx) 845 and a receiver (Rx) 847 for enabling apparatus 800 to transmit data to and receive data from other nodes connected to a network 110 (e.g., an Internet Protocol (IP) network) to which network interface 848 is connected (directly or indirectly) (e.g., network interface 848 may be wirelessly connected to the network 110, in which case network interface 848 is connected to an antenna arrangement); and a storage unit (a.k.a., “data storage system”) 808, which may include one or more non-volatile storage devices and/or one or more volatile storage devices. In embodiments where PC 801 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 801, the CRI causes apparatus 800 to perform steps described herein (e.g., steps described herein with reference to the flow charts). In other embodiments, apparatus 800 may be configured to perform steps described herein without the need for code. That is, for example, PC 801 may consist merely of one or more ASICs. Hence, the features of the embodiments described herein may be implemented in hardware and/or software.

As demonstrated by the description above, given estimates of 3D point of the cell tower ground Z₀, 3D point of the cell tower top Z_{H}, camera intrinsic parameters (focal length f and image dimensions H_{J}), one can calculate the optimal offset in horizontal and vertical direction (KD and KZ_{M}) to automatically position the drone at the TSO orbit. That is, given an estimate of the height of the cell tower, as well as, camera intrinsic parameters (only focal length and image dimensions are the required intrinsic parameters), the drone performs vertical and horizontal steps of certain size, which brings it to a preferred position for TSO orbit data acquisition. From that position tower may be viewed at 45° down and the projection often tower on the image plane occupies 90% of the image height.

While various embodiments are described herein, it should be understood that they have been presented by way of example only, and not limitation. Thus, the breadth and scope of this disclosure should not be limited by any of the above described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for obtaining information about a structure using a drone equipped with a sensor system, the method being performed by an apparatus and comprising:
during a first period of time and while the drone's sensor system is pointing towards the structure, using the sensor system to obtain first depth data;
obtaining a first height value (Z1) indicating or being based on the height of the drone above a bottom point of the structure during the first period of time;
using the first depth data to determine a first vertical coordinate representing a top point of the structure; and
estimating a height of the structure, wherein estimating the height of the structure comprises using the first vertical coordinate and the first height value to estimate the height of the structure.

2. The method of claim 1, wherein estimating the height of the structure comprises:
using the determined first vertical coordinate and a first reference vertical coordinate to determine a first distance value (d1); and
using d1 and Z1 to estimate the height of the structure.

3. The method of claim 2, further comprising:
during a second period of time and while the drone's sensor system is pointing towards the structure, using the sensor system to obtain second depth data;
obtaining a second height value (Z2) indicating or being based on the height of the drone above a bottom point of the structure during the second period of time; and
using the second depth data to determine a second vertical coordinate representing a top point of the structure, wherein
estimating the height of the structure further comprises using the second vertical coordinate and the second height value to estimate the height of the structure.

4. The method of claim 3, wherein estimating the height of the structure further comprises:
using the determined second vertical coordinate and a second reference vertical coordinate to determine a second distance value (d2); and
using d1, d2, Z1, and Z2 to estimate the height of the structure.

5. The method of claim 3, wherein
the first depth data consists of a first set of distance values,
the first depth data is filtered depth data that was filtered such that each distance value included in the first set of distance values is not greater than a threshold distance,
the second depth data consists of a second set of distance values, and
the second depth data is filtered depth data that was filtered such that each distance value included in the second set of distance values is not greater than the threshold distance.

6. The method of claim 4, wherein estimating the height of the structure using d1, d2, Z1, and Z2 comprises calculating:
$$( d 2 / ( d 1 + d 2 ) ) \times Z 1 + ( 1 - ( d 2 / ( d 1 + d 2 ) ) ) \times Z 2 , or$$
$$( 1 - ( d 1 / ( d 1 + d 2 ) ) ) \times Z 1 + ( d 1 / ( d 1 + d 2 ) ) ) \times Z 2.$$

7. The method of claim 6, wherein
d1 indicates a number of pixels between the first vertical coordinate and the first reference vertical coordinate, and
d2 indicates a number of pixels between the second vertical coordinate and the second reference vertical coordinate.

8. The method of claim 4, wherein estimating the height of the structure using d1, d2, Z1, and Z2 comprises calculating:
$$( ( Z 1 + d 1 ) + ( Z 2 - d 2 ) ) / 2.$$

9. The method of claim 2, wherein estimating the height of the structure comprises calculating:
Z1+d1, or
Z1−d1.

10. The method of claim 1, wherein the sensor system comprises:
a laser; and
a light detector.

11. A method for obtaining coordinates associated with a structure, the method being performed by an apparatus and comprising:
positioning a drone above the structure, wherein the drone is equipped with a sensor system;
while the drone is above the structure and the drone's sensor system is pointing towards the structure, using the sensor system to obtain first depth data;
based on the first depth data, identifying a point-of-interest on the structure;
determining a position of the point-of-interest in a two dimensional plane;
based on the determined position of the point-of-interest in the two dimensional plane, determining whether or not the drone should be re-positioned;
if it is determined that the drone should be re-positioned, causing the drone to move to a new position;
determining x and y coordinates of a current position of the drone; and
setting x and y coordinates for the point-of-interest based on the determined x and y coordinates of the current position of the drone.

12. The method of claim 11, further comprising:
prior to positioning the drone above the structure, estimating a height of the structure.

13. The method of claim 12, wherein estimating the height of the structure comprises:
during a first period of time and while the drone's sensor system is pointing towards the structure, using the sensor system to obtain first depth data;
obtaining a first height value (Z1) indicating or being based on the height of the drone above a bottom point of the structure during the first period of time;
using the first depth data to determine a first vertical coordinate representing a top point of the structure; and
estimating a height of the structure, wherein estimating the height of the structure comprises using the first vertical coordinate and the first height value to estimate the height of the structure.

14. (canceled)

15. The method of claim 11, wherein the point-of-interest is a centroid.

16. The method of claim 11, wherein
the first depth data consists of a first set of distance values, and
the first depth data is filtered depth data that was filtered such that each distance value included in the first set of distance values is not greater than a threshold distance.

17. The method of claim 16, wherein the threshold distance is based on the distance between the drone and the top of the tower.

18. A non-transitory computer readable storage medium storing a computer program comprising instructions which when executed by processing circuitry of an apparatus causes the apparatus to perform the method of claim 1.

19. A non-transitory computer readable storage medium storing a computer program comprising instructions which when executed by processing circuitry of an apparatus causes the apparatus to perform the method of claim 11.

20. (canceled)

21. An apparatus for obtaining information about a structure using a drone equipped with a sensor system, wherein the apparatus comprises:
a computer readable storage medium; and
processing circuitry coupled to the computer readable storage medium, wherein the apparatus is configured to:
during a first period of time and while the drone's sensor system is pointing towards the structure, use the sensor system to obtain first depth data;
obtain a first height value (Z1) indicating or being based on the height of the drone above a bottom point of the structure during the first period of time;
use the first depth data to determine a first vertical coordinate representing a top point of the structure; and
estimate a height of the structure, wherein estimating the height of the structure comprises using the first vertical coordinate and the first height value, Z1, to estimate the height of the structure.

22. (canceled)

23. An apparatus for obtaining coordinates associated with a structure, wherein the apparatus comprises:
a computer readable storage medium; and
processing circuitry coupled to the computer readable storage medium, wherein the apparatus is configured to:
position a drone above the structure, wherein the drone is equipped with a sensor system;
while the drone is above the structure and the drone's sensor system is pointing towards the structure, use the sensor system to obtain first depth data;
based on the first depth data, identify a point-of-interest on the structure;
determine a position of the point-of-interest in a two dimensional plane;
based on the determined position of the point-of-interest in the two dimensional plane, determine whether or not the drone should be re-positioned;
if it is determined that the drone should be re-positioned, cause the drone to move to a new position;
determine x and y coordinates of a current position of the drone; and
set x and y coordinates for the point-of-interest based on the determined x and y coordinates of the current position of the drone.

24. (canceled)

25. (canceled)
